(19) United States
(12) Patent Application Publication
(10) Pub. No.: US 2016/0328003 A1
(43) Pub. Date: Nov. 10, 2016

(54) POWER SAVING APPARATUS OF CAPACITIVE POINTER

(71) Applicant: WALTOP INTERNATIONAL CORPORATION, Hsinchu City (TW)

(72) Inventor: A-Li Wong, Hsinchu City (TW)

(21) Appl. No.: 14/802,976

(22) Filed: Jul. 17, 2015

(30) Foreign Application Priority Data
May 8, 2015 (TW) 104114741

(51) Int. Cl. G06F 1/32; G06F 3/041; G06F 3/044

(52) U.S. Cl. CPC G06F 1/3262; G06F 3/044; G06F 3/0416

(57) ABSTRACT

A power saving apparatus of a capacitive pointer is disclosed. The power saving apparatus of a capacitive pointer comprises an amplifier circuit, a first comparator circuit and a second comparator circuit, a controller and a switch. The first comparator circuit provides a first voltage level and receives an amplified driving signal, and the second comparator circuit provides a second voltage level and receives the amplified driving signal, wherein the first voltage level is higher than the second voltage level. The power saving apparatus determines whether the switch is turned on or off to provide an output signal through comparing the first voltage level and the voltage level of the amplified driving signal.

### CROSS-REFERENCE TO RELATED APPLICATIONS

The entire contents of Taiwan Patent Application No. 104114741, filed on May 8, 2015, from which this application claims priority, are expressly incorporated herein by reference.

1. Field of the Invention

The present invention relates to a power saving apparatus, and more particularly to a power saving apparatus of capacitive pointer.

2. Description of the Prior Art

Capacitive touch input technology is widely used in the touch panel, one of advantages is allowing user to proceed input operation via user's hand or a capacitive pointer so as to have a multi touch function which can generate a variety of applications according to specific corresponding operations by various gestures. A capacitive pointer allows user to perform exquisite input operations such as writing or to execute application programs on a touch panel via user interfaces. The coordinates of a capacitive pointer can be detected via capacitive coupling between detection electrodes of a touch panel and the capacitive pointer when the capacitive pointer approaches or contacts the touch panel. In order to establish capacitive coupling with detection electrodes of a touch panel, a capacitive pointer must receive driving signals from detection electrodes and output signals to detection electrodes so that coordinates of the capacitive pointer can be detected. In order to maintain operation, a capacitive pointer must continue receiving driving signals from detection electrodes and outputting signals. However, continuing to output signals is not always necessary and continuous high voltage output also consumes electrical energy quickly. Thus the invention provides a power saving apparatus of capacitive pointer which outputs high voltage signals according to predetermined parameters to save unnecessary electrical power consumption and to achieve objective of power saving.

### SUMMARY OF THE INVENTION

An object of the present invention is to provide a power saving apparatus of capacitive pointer which outputs signals only when a voltage level of driving signal is higher than a. predetermined voltage level. If the voltage level of driving signal is lower than the predetermined voltage level, the capacitive pointer will not output signals so as to save electrical power of the capacitive pointer.

According to the object, one embodiment of the present invention provides a power saving apparatus of capacitive pointer comprising an amplifier circuit, a first comparator circuit, a controller, a switch and a second comparator circuit. The amplifier circuit receives a driving signal and generates an amplified driving signal with a voltage level. The first comparator circuit generates a first voltage level and receives the amplified driving signal with the voltage level. The first comparator circuit compares the voltage level and the first voltage level and generates a first comparator circuit signal. The controller receives the first comparator circuit signal and generates a controller signal. The switch determines whether an output signal from a high voltage output can be outputted or not. The second comparator circuit generates a second voltage level and receives the controller signal. The second comparator circuit compares the voltage level and the second voltage level and generates a second comparator circuit signal, wherein the controller signal determines whether the second comparator circuit signal turns on the switch so that the high voltage output can output the output signal, the first voltage level is higher than the second voltage level.

Another embodiment of the present invention provides a power saving apparatus of capacitive pointer comprising a first amplifier circuit and a second amplifier circuit, a first comparator circuit, a controller, a switch, and a second comparator circuit. The first and second amplifier circuits receive a driving signal and generate an amplified driving signal with a voltage level. The first comparator circuit generates a first voltage level and receives the amplified driving signal with the voltage level. The first comparator circuit compares the voltage level and the first voltage level and generates a first comparator circuit signal. The controller receives the first comparator circuit signal and generates a controller signal. The switch determines whether an output signal from a high voltage output can be outputted or not. The second comparator circuit generates a second voltage level and receives the controller signal. The second comparator circuit compares the voltage level and the second voltage level and generates a second comparator circuit signal, wherein the controller signal determines whether the second comparator circuit signal turns on the switch so that the high voltage output can output the output signal, and the first voltage level is higher than the second voltage level.

Another embodiment of the present invention provides a power saving apparatus of capacitive pointer comprising at least one amplifier circuit, a first comparator circuit, a second comparator circuit, a switch, and a controller. The amplifier circuit receives a driving signal and generates an amplified driving signal with a voltage level. The first comparator circuit generates a first voltage level and receives the amplified driving signal with the voltage level. The first comparator circuit compares the voltage level and the first voltage level and generates a first comparator circuit signal. The second comparator circuit generates a second voltage level and receives the controller signal. The second comparator circuit compares the voltage level and the second voltage level and generates a second comparator circuit signal, wherein the first voltage level is higher than the second voltage level. The switch determines whether an output signal from a high voltage output can be outputted or not. The controller receives the first comparator circuit signal and the second comparator circuit signal and generates a controller signal, wherein the controller signal determines whether the switch turns on or remains off so that the high voltage output can output the output signal,.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A is a schematic block diagram of a power saving apparatus of capacitive pointer according to one embodiment of the invention.

FIG. 1B is a schematic block diagram of a power saving apparatus of capacitive pointer according to another embodiment of the invention.

FIG. 1C is a schematic block diagram of a power saving apparatus of capacitive pointer according to another embodiment of the invention.

FIG. 2A is a circuit diagram of a power saving apparatus of capacitive pointer according to one embodiment of the invention.

FIG. 2B is a circuit diagram of a power saving apparatus of capacitive pointer according to another embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

In embodiments of the invention, some features related to a capacitive pointer which are not essential to the invention and are well known for any person skilled in the art to make and use the same will not be described in detail herein. For example, the following features relating to a capacitive pointer and a touch panel are well known for any person skilled in the art to make and use the same. A capacitive pointer includes a conductive tip while a touch panel has a capacitive detection array with a plurality of detection electrodes, wherein the detection electrodes comprise transmitting electrodes (Tx) and receiving electrodes (Rx). When a capacitive pointer is used upon a touch panel, the conductive tip approaches or contacts the capacitive detection array of the touch panel, and the conductive tip of the capacitive pointer will establish capacitive coupling with the detection electrodes under or adjacent the capacitive pointer which provide the capacitive pointer with driving signals. The capacitive pointer outputs a signal to the detection electrodes under or adjacent the capacitive pointer after receiving and processing the driving signals. Through capacitive coupling between the conductive tip and the detection electrodes, the signal from the capacitive pointer will be detected during scanning transmitting electrodes and receiving electrodes so that coordinates of the capacitive pointer can be calculated and determined. The capacitive detection array can use charge accumulation circuit, a capacitance modulation circuit, or other capacitance sensing methods known by those skilled in the art.

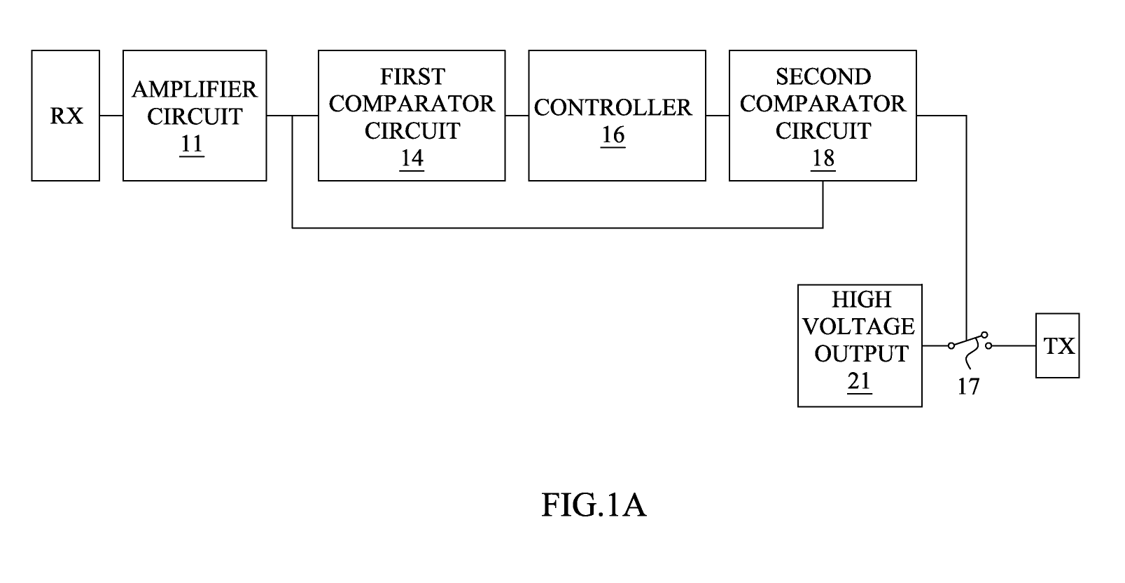

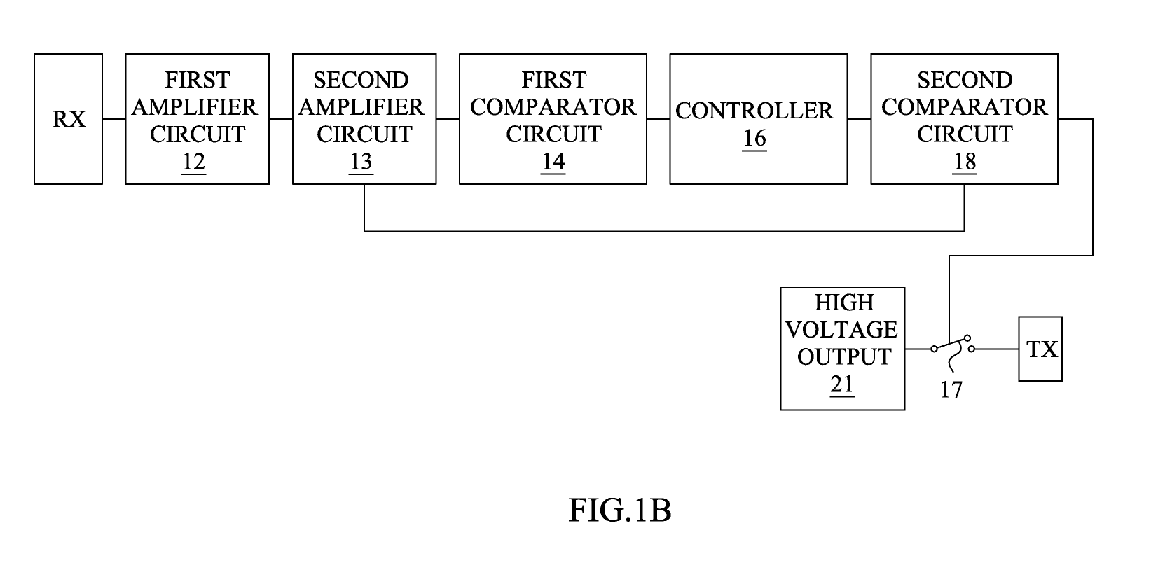

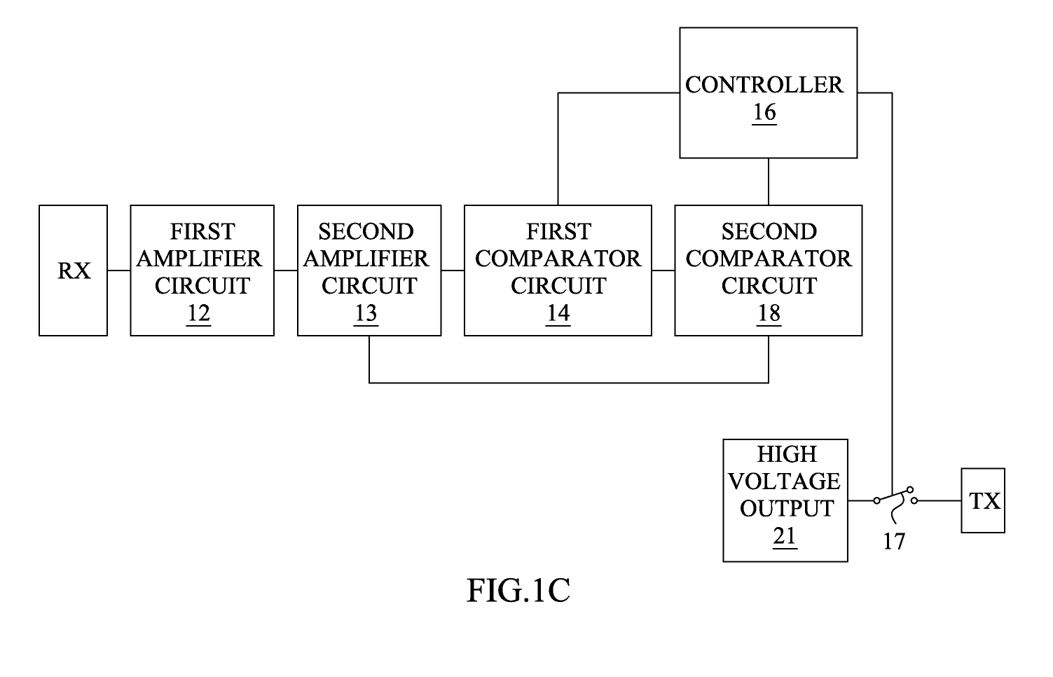

FIG. 1A is a schematic block diagram of a power saving apparatus of capacitive pointer according to one embodiment of the invention. In this embodiment, the power saving apparatus of capacitive pointer comprises an amplifier circuit 11, a first comparator circuit 14, a second comparator circuit 18, a controller 16, a switch 17 and a high voltage output 21. When the conductive tip of a capacitive pointer establishes capacitive coupling with detection electrodes of a capacitive detection array in a touch panel, the capacitive pointer receives driving signals from the detection electrodes. First of all, the driving signals are amplified through the amplifier circuit 11. Since the driving signal usually accompanies environment noises, the driving signal is filtered to have a voltage level before being amplified by the amplifier circuit 11. The first comparator circuit 14 has a first voltage level, and the second comparator circuit 18 has a second voltage level. Then the amplified and filtered driving signal having a voltage level is transmitted to the first comparator circuit 14 and the second comparator circuit 18, wherein the first comparator circuit 14 is used to compare the voltage level and the first voltage level, and the second comparator circuit 18 compares the voltage level and the second voltage level. The first voltage level is higher than the second voltage level, or the first voltage level is a higher voltage level while the second voltage level is a lower voltage level or a regular voltage level. The first voltage level and the second voltage level can be set according to requirement so as to achieve objective of power saving. After the first comparator circuit 14 compares the voltage level and the first voltage level, the first comparator circuit 14 transmits a first comparator circuit signal to the controller 16. The controller 16 transmits a controller signal to the second comparator circuit 18 according to the first comparator circuit signal. The second comparator circuit 18 compares the voltage level of the driving signal from the amplifier circuit 11 and the second voltage level to output a second comparator circuit signal. The controller signal determines whether the second comparator circuit signal turns on the switch 17 so that the high voltage output 21 can output an output signal. The output signal allows the capacitive pointer to establish capacitive coupling with detection electrodes of a touch panel under or adjacent the capacitive pointer after scanning transmitting electrodes and receiving electrodes of the detection electrodes to generate a detection signal so as to calculate and determine coordinates of the capacitive pointer.

If the voltage level of the driving signal is lower than the first voltage level, the controller signal determines that the second comparator circuit signal maintains the switch 17 at off status so that the high voltage output 21 cannot outputs a output signal. If the voltage level of the driving signal is higher than the first voltage level, the controller signal determines that the second comparator circuit signal turns on the switch 17 so that the high voltage output 21 can outputs an output signal. Thus only when the voltage level of the driving signal is higher than the first voltage level, the capacitive pointer will output a output signal so as to save electrical power of the capacitive pointer.

FIG. 1B is a schematic block diagram of a power saving apparatus of capacitive pointer according to another embodiment of the invention. In this embodiment, the power saving apparatus of capacitive pointer comprises a first amplifier circuit 12, a second amplifier circuit 13, a first comparator circuit 14, a second comparator circuit 18, a controller 16, a switch 17 and a high voltage output 21. Comparing to the power saving apparatus of capacitive pointer shown in FIG. 1A, this power saving apparatus uses the first amplifier circuit 12 and the second amplifier circuit 13 to amplify and filter driving signals and to generate a voltage level. The amplified and filtered driving signal having a voltage level from the first amplifier circuit 12 and the second amplifier circuit 13 is transmitted to the first comparator circuit 14 and the second comparator circuit 18: The first comparator circuit 14 has a first voltage level, and the second comparator circuit 18 has a second voltage level, wherein the first voltage level is higher than the second voltage level. After the first comparator circuit 14 compares the voltage level and the first voltage level, the first comparator circuit 14 transmits a first comparator circuit signal to the controller 16. The controller 16 transmits a controller signal to the second comparator circuit 18 according to the first comparator circuit signal. The second comparator circuit 18 compares the voltage level and the second voltage level to output a second comparator circuit signal. The controller signal determines whether the second comparator circuit signal turns on the switch 17 so that the high voltage output 21 can outputs a output signal.

FIG. 1C is a schematic block diagram of a power saving apparatus of capacitive pointer according to another embodiment of the invention. In this embodiment, the power saving apparatus of capacitive pointer comprises a first amplifier circuit 12, a second amplifier circuit 13, a first comparator circuit 14, a second comparator circuit 18, a controller 16, a switch 17 and a high voltage output 21. Comparing to the power saving apparatus of capacitive pointer shown in FIG. 1B, this power saving apparatus uses the controller 16 to control the switch 17 to determine whether the high voltage output 21 can outputs a output signal. The amplified and filtered driving signal having a voltage level from the first amplifier circuit 12 and the second amplifier circuit 13 is transmitted to the first comparator circuit 14 and the second comparator circuit 18. The first comparator circuit 14 has a first voltage level, and the second comparator circuit 18 has a second voltage level, wherein the first voltage level is higher than the second voltage level. After the first comparator circuit 14 compares the voltage level and the first voltage level, the first comparator circuit 14 transmits a first comparator circuit signal to the controller 16. The second comparator circuit 18 compares the voltage level and the second voltage level to output a second comparator circuit signal to the controller 16. The controller 16 transmits a controller signal to the switch 17 according to the first comparator circuit signal and the second comparator circuit signal to determine whether the switch 17 is turned on or off so that the high voltage output 21 can outputs a output signal.

If the voltage level of the driving signal is lower than the first voltage level, the controller 16 determines that the switch 17 maintains at off status so that the high voltage output 21 cannot outputs a output signal. If the voltage level of the driving signal is higher than the first voltage level, the controller 16 turns on the switch 17 so that the high voltage output 21 can outputs a output signal. Thus only when the voltage level of the driving signal is higher than the first voltage level the capacitive pointer will output a output signal so as to save electrical power of the capacitive pointer.

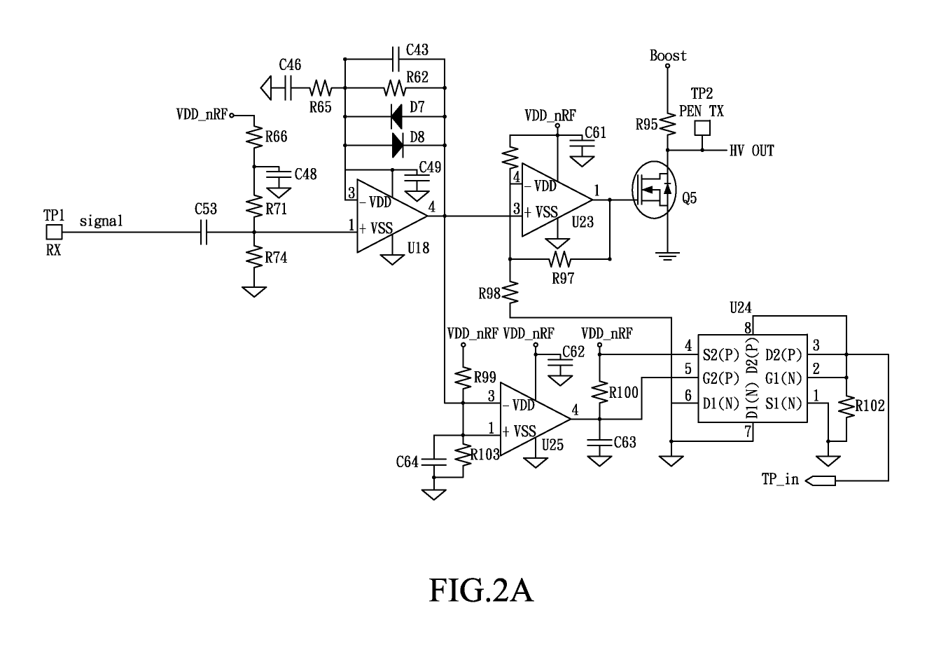

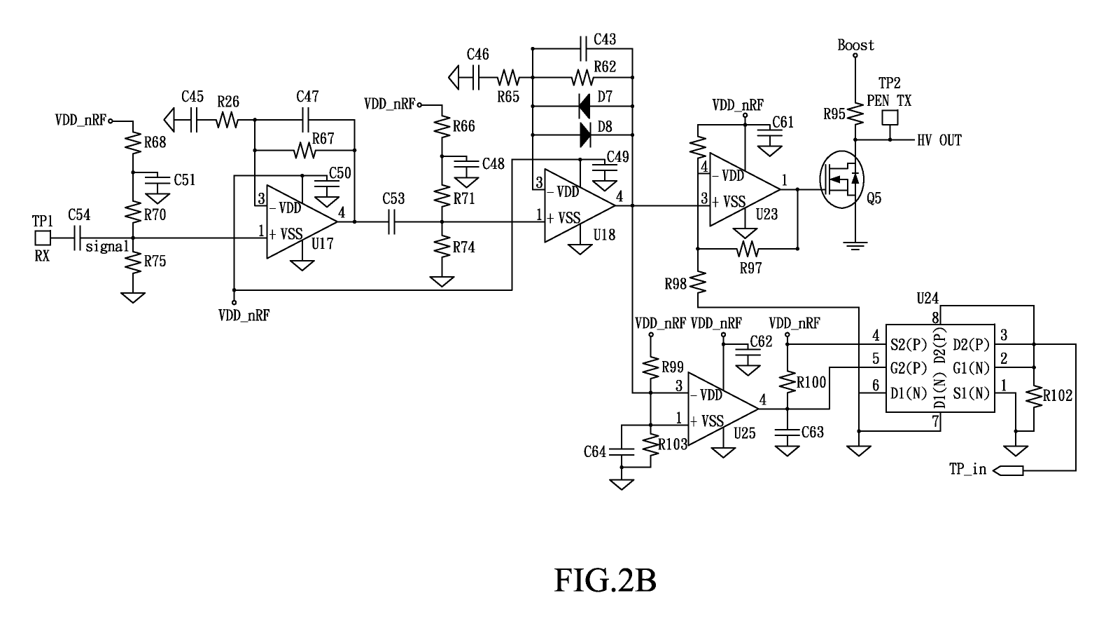

FIG. 2A is a circuit diagram of a power saving apparatus of capacitive pointer according to one embodiment of the invention. As shown in FIG. 2A, capacitor C53 is used to filter driving signals, and the circuit comprising resistors R66, R71, R74 and capacitor C48 is used to generate a voltage level of driving signal. The amplifier circuit comprising amplifier U18, capacitors C43, C46, C49, resistors R62, R65, and diodes D7, D8 is used to amplify driving signals, wherein diodes D7, D8 are used to prevent amplifier U18 from being saturated . The first comparator circuit comprising comparator U25, capacitors C62, C64 and resistors R99, R103 is used to provide a first voltage level and to compare the voltage level and the first voltage level and to generate a first comparator circuit signal, wherein capacitor C64 and resistors R99, R103 are used to provide the first voltage level. The control circuit comprising controller device U24, capacitor C63 and resistors R100, R102 generates a controller signal according to the first comparator circuit signal. Controller device U24 comprises any suitable digital or analog switch devices, such as metal oxide semiconductor devices. The second comparator circuit comprising comparator U23, capacitor C61 and resistors R96, R97, R98 is used to provide a second voltage level and to compares the voltage level and the second voltage level to generate a second comparator circuit signal. The controller signal determines whether the second comparator circuit signal turns on the switch comprising transistor Q5 so that the high voltage output can outputs a output signal. Capacitor C61 and resistors R96, R98 are used to generate the second voltage level, and the first voltage level is higher than the second voltage level. The circuit diagram of a power saving apparatus of capacitive pointer shown in FIG. 2A is one example instead of limitations, any equivalents, alternatives or modifications of the embodiment corresponding to the spirit of invention should be encompassed in the scope of the invention. Other circuit designs or components can be used depending on requirements of design.

FIG. 2B is a circuit diagram of a power saving apparatus of capacitive pointer according to another embodiment of the invention. As shown in FIG. 2B, the power saving apparatus further comprises another circuit for providing voltage level of driving signal and another amplifier circuit comparing to the power saving apparatus shown in FIG. 2A. Capacitor C54 is used to filter driving signals, and the circuit comprising resistors R68, R70, R75 and capacitor C51 is used to generate a voltage level of driving signal. The first amplifier circuit comprising amplifier U17, capacitors C45, C47, C50, and resistors R26, R27 is used to amplify driving signals. Similar to the power saving apparatus shown in FIG. 2A, capacitor C53 is also used to filter driving signals, and the circuit comprising resistors R66, R71, R74 and capacitor C48 is used to generate a voltage level of driving signal. The amplifier circuit comprising amplifier U18, capacitors C43, C46, C49, resistors R62, R65, and diodes D7, D8 is used to amplify driving signals, wherein diodes D7, D8 are used to prevent amplifier U18 from being saturated. The first comparator circuit comprising comparator U25, capacitors C62, C64 and resistors R99, R103 is used to provide a first voltage level and to compare the voltage level and the first voltage level and to generate a first comparator circuit signal, wherein capacitor C64 and resistors R99, R103 are used to provide the first voltage level. The control circuit comprising controller device U24, capacitor C63 and resistors R100, R102 generates a controller signal according to the first comparator circuit signal. Controller device

U24 comprises any suitable digital or analog switch devices, such as metal oxide semiconductor devices. The second comparator circuit comprising comparator U23, capacitor C61 and resistors R96, R97, R98 is used to provide a second voltage level and to compares the voltage level and the second voltage level to generate a second comparator circuit signal. The controller signal determines whether the second comparator circuit signal turns on the switch comprising transistor Q5 so that the high voltage output can outputs a output signal. Capacitor C61 and resistors R96, R98 are used to generate the second voltage level, and the first voltage level is higher than the second voltage level. The circuit diagram of a power saving apparatus of capacitive pointer shown in FIG. 2B is another example instead of limitations, any equivalents, alternatives or modifications of the embodiment corresponding to the spirit of invention should be encompassed in the scope of the invention. Other circuit designs or components can be used depending on requirements of design.

The power saving apparatus of capacitive pointer of the invention outputs signals only when a voltage level of driving signal higher than predetermined voltage levels. The capacitive pointer establishes capacitive coupling with detection electrodes of a touch panel under or adjacent the capacitive pointer after scanning transmitting electrodes and receiving electrodes of the detection electrodes to generate a detection signal so as to calculate and determine coordinates of the capacitive pointer. If the voltage level of driving signal is lower than the predetermined voltage level, the capacitive pointer will not outputs an output signal so that the capacitive pointer will not establish capacitive coupling with detection electrodes under or adjacent the capacitive pointer so as to save electrical power of the capacitive pointer.

Although specific embodiments have been illustrated and described, it will be appreciated by those skilled in the art that various modifications may be made without departing from the scope of the present invention, which is intended to be limited solely by the appended claims.

What is claimed is:

1. A power saving apparatus of capacitive pointer, comprising:
an amplifier circuit, the amplifier circuit receiving a driving signal and generating an amplified driving signal with a voltage level;
a first comparator circuit, the first comparator circuit generating a first voltage level and receiving the amplified driving signal with the voltage level, the first comparator circuit comparing the voltage level and the first voltage level and generating a first comparator circuit signal;
a controller, the controller receiving the first comparator circuit signal and generating a controller signal;
a switch, the switch determining whether an output signal from a high voltage output can be outputted or not; and
a second comparator circuit, the second comparator circuit generating a second voltage level and receiving the controller signal, the second comparator circuit comparing the voltage level and the second voltage level and generating a second comparator circuit signal, wherein the controller signal determines whether the second comparator circuit signal turns on the switch so that the high voltage output can output the output signal, the first voltage level is higher than the second voltage level.

2. The power saving apparatus of capacitive pointer according to claim 1, wherein the controller comprise digital or analog switch devices

3. The power saving apparatus of capacitive pointer according to claim 2, wherein the switch devices comprise metal oxide semiconductor devices.

4. The power saving apparatus of capacitive pointer according to claim 1, wherein the switch comprises a transistor.

5. The power saving apparatus of capacitive pointer according to claim 1 further comprising a circuit for generating the voltage level of driving signal.

6. A power saving apparatus of capacitive pointer, comprising:
a first amplifier circuit and a second amplifier circuit, the first and second amplifier circuits receiving a driving signal and generating an amplified driving signal with a voltage level;
a first comparator circuit, the first comparator circuit generating a first voltage level and receiving the amplified driving signal with the voltage level, the first comparator circuit comparing the voltage level and the first voltage level and generating a first comparator circuit signal;
a controller, the controller receiving the first comparator circuit signal and generating a controller signal;
a switch, the switch determining whether an output signal from a high voltage output can be outputted or not; and
a second comparator circuit, the second comparator circuit generating a second voltage level and receiving the controller signal, the second comparator circuit comparing the voltage level and the second voltage level and generating a second comparator circuit signal, wherein the controller signal determines whether the second comparator circuit signal turns on the switch so that the high voltage output can output the output signal, the first voltage level is higher than the second voltage level.

7. The power saving apparatus of capacitive pointer according to claim 6 further comprising a circuit for generating the voltage level of driving signal.

8. A power saving apparatus of capacitive pointer, comprising:
at least one amplifier circuit, the amplifier circuit receiving a driving signal and generating an amplified driving signal with a voltage level;
a first comparator circuit, the first comparator circuit generating a first voltage level and receiving the amplified driving signal with the voltage level, the first comparator circuit comparing the voltage level and the first voltage level and generating a first comparator circuit signal;
a second comparator circuit, the second comparator circuit generating a second voltage level and receiving the controller signal, the second comparator circuit comparing the voltage level and the second voltage level and generating a second comparator circuit signal, wherein the first voltage level is higher than the second voltage level;
a switch, the switch determining whether an output signal from a high voltage output can be outputted or not; and
a controller, the controller receiving the first comparator circuit signal and the second comparator circuit signal and generating a controller signal, wherein the controller signal determines whether the switch turns on or remains off so that the high voltage output can output the output signal.

9. The power saving apparatus of capacitive pointer according to claim 8 further comprising a circuit for generating the voltage level of driving signal.
